(19) United States
(12) Patent Application Publication
(10) Pub. No.: US 2026/0342243 A1
(43) Pub. Date: Oct. 29, 2026

(54) PIEZOELECTRIC MOTION- AND RESONANCE DRIVE

(71) Applicant: PHYSIK INSTRUMENTE (PI) SE & CO. KG, Karlsruhe (DE)

(72) Inventor: Burhanettin KOC, Ettlingen (DE)

(21) Appl. No.: 19/099,794

(22) PCT Filed: Jul. 14, 2023
(86) PCT No.: PCT/EP2023/069663

§ 371 Date: Jan. 30, 2025

(30) Foreign Application Priority Data
Aug. 1, 2022 (DE) 10 2022 119 245.8

(51) Int. Cl. H02N 2/06; H02N 2/04

(52) U.S. Cl. CPC H02N 2/06; H02N 2/04

(57) ABSTRACT

A piezoelectric motion-and resonance drive and a method for actuating a piezoelectric motion-and resonance drive are provided. The drive comprises a moving member and at least one drive unit comprising an assembly of a plurality of piezoelectric actuators and a frictional element which is designed to come into contact with the moving member, wherein the assembly of the piezoelectric actuators and the frictional element are coupled in such a way that, upon actuation of the piezoelectric actuators, the frictional element can perform both a contact movement towards the moving member or away therefrom, in order to establish or terminate contact with the moving member, and a drive movement along the moving member in order to drive the moving member. The aim of the invention is cost-effective and simple production. To achieve this aim, each of the piezoelectric actuators of the assembly is a linear actuator.

### CROSS REFERENCE TO RELATED APPLICATIONS

This application is a 371 U.S. National Phase of International Application No. PCT/EP2023/069663, filed on Jul. 14, 2023, which claims priority to German Patent Application No. 10 2022 119 245.8, filed Aug. 1, 2022. The entire disclosures of the above applications are incorporated herein by reference.

### BACKGROUND

### Technical Field

The present invention relates to a piezoelectric motion-and resonance drive, as well as to a method for actuating a piezoelectric motion-and resonance drive.

### Related Art

Piezoelectric motion-and resonance drives essentially comprise a moving member and one or more drive units. A drive unit includes an arrangement of piezoelectric actuators and a frictional element adapted to come into contact with the moving member. In principle, it is provided that, upon suitable actuation of the actuators, the assembly of actuators causes a movement of the frictional element towards the moving member or away therefrom in order to establish or terminate contact with the moving member and causes a movement of the frictional element along the moving member to drive it. Such drives are disclosed, for example, in DE 197 15 226 A1 and US 2010/0148629 A1.

In the drives known from DE 197 15 226 A1 and US 2010/0148629 A1, shear actuators or bending actuators are used. Such actuators have the disadvantage that they are complex to manufacture and can only be produced at high cost. In addition, multilayer shear actuators have the disadvantage that their ceramic layers are comparatively thick, which increases the overall installation height of the actuator. At the same time, such actuators can only be operated at high voltages.

In view of the disadvantages of the known drives as shown above, the object of the present invention is to provide a piezoelectric motion-and resonance drive that can be manufactured at low cost and with little effort and requires only low actuation voltages.

### SUMMARY

This problem is solved by a piezoelectric motion-and resonance drive. According to the invention, each of the piezoelectric actuators of the assembly is a linear actuator. Linear actuators are generally inexpensive and easy to manufacture. In addition, they can be operated with comparatively low actuation voltages, which facilitates the configuration of the entire control system.

Preferred further developments are also provided.

It can be advantageous if the assembly of the piezoelectric actuators and the frictional element are coupled in such a way that upon actuation of the piezoelectric actuators, the frictional element can perform the contact movement and the drive movement either independently of each other or in an overlapping manner. Depending on the actuation of the linear actuators, various movement paths of the frictional element can be realized.

It can be useful if the drive movement is in a plane or along an axis perpendicular to an axis of the contact movement. This allows the contact pressure of the frictional element, which is generated by the contact movement and is required to drive the moving member, to be set optimally to generate static friction between the frictional element and the underside of the moving member and to be matched to the drive force.

It may be convenient for the drive unit to comprise a base carrying the assembly of piezoelectric actuators, wherein the contact movement preferably occurs perpendicular to the base and/or the drive movement occurs parallel to the base. Due to the fact that the actuators are mounted on a base, a self-contained drive unit can be provided and the assembly of the drive unit in a superordinate structure, such as a frame, can be facilitated.

It may be preferable for the piezoelectric actuators in the assembly to be deflected in parallel directions upon actuation, preferably parallel to the axis of contact movement. All linear actuators in the assembly are thus oriented in the same way, which simplifies the structure of the assembly and makes the assembly itself compact.

It can be useful if each of the piezoelectric actuators is a multilayer stack actuator configured to produce a deflection along its stacking axis, which is preferably oriented parallel to the axis of contact movement. Multilayer stack actuators can be produced easily, inexpensively and quickly by sintering green films.

It may be preferable for the piezoelectric actuators to be assigned to separately actuable actuator units, wherein the frictional element performs the contact movement upon actuation of a first actuator unit with at least one of the piezoelectric actuators and performs the driving movement upon actuation of a second actuator unit with at least one, preferably two, other of the piezoelectric actuators. The movement components of the frictional element are assigned to individual drive units, which simplifies the configuration of the control system.

It can be practical if the piezoelectric actuators within the assembly are provided in several, preferably two, planes, wherein preferably all piezoelectric actuators of the same actuator unit are arranged in the same plane. By providing the actuators in several planes, a compact arrangement of the actuators can be realized, in which the actuators of the different planes can interact by coupling.

It can be useful if a carrier is arranged between two planes and the piezoelectric actuators of the different planes are coupled to each other via the carrier. With the aid of the carrier, the deformation movement of the actuators in one plane can be transmitted to the other plane, whereby the deformation movements of the actuators of different planes can be combined.

It can be advantageous if the frictional element is connected to two piezoelectric actuators arranged next to each other within the assembly, preferably via a base that carries the frictional element. The interaction of the two actuators can enable a movement of the frictional element that is suitable for driving the moving member, in particular a tilting movement.

It can be useful if the drive unit is mounted in a frame, preferably over a carrier that penetrates the assembly of piezoelectric actuators, and/or a spring element that biases the assembly of piezoelectric actuators against the frame, and particularly preferably has a recess through which the frictional element protrudes. By means of the carrier and the spring element, the drive unit can be easily mounted in the frame.

It can be advantageous if the assembly of the piezoelectric actuators comprises three piezoelectric actuators, wherein one piezoelectric actuator is arranged in a first plane and two piezoelectric actuators are arranged in a second plane located above the first plane, wherein the two piezoelectric actuators of the second plane are arranged next to each other. This assembly is highly compact and functional in terms of generating the contact movement and the driving movement of the frictional element.

It can be useful if at least two drive units are arranged next to each other in a direction parallel to the direction of the drive movement, or if at least three drive units are arranged along a circular path. These configurations can be used to provide a linear drive with an extended stroke of the moving member or increased drive force, or a rotational drive.

It can be advantageous if the drive has a control unit for controlling the piezoelectric actuators with electrical control voltages. With the aid of a control unit, the linear actuators can be easily actuated with electrical control voltages.

Another aspect of the present invention relates to a method for actuating a piezoelectric motion-and resonance drive, which comprises: a moving member, and at least one drive unit, which comprises an assembly of several piezoelectric linear actuators and a frictional element adapted to come into contact with the moving member, wherein at least one piezoelectric linear actuator of the assembly is actuated in such a way that the frictional element performs a contact movement towards the moving member or away therefrom in order to establish or terminate contact with the moving member, and at least one other piezoelectric linear actuator, preferably two other piezoelectric linear actuators, of the assembly is/are actuated in such a way that the frictional element performs a driving movement along the moving member.

It may be preferred that the two piezoelectric linear actuators that provide the driving movement of the frictional element are actuated in such a way that they behave inversely phased. This makes it particularly easy to realize the driving movement of the frictional element.

### TERMS AND DEFINITIONS

### Linear Actuator

The term “linear actuator” describes an actuator that is adapted to perform a deformation that can be used for a drive, i.e. an expansion or contraction, exclusively along an effective direction. The expansion or contraction of the actuator may be accompanied by a constriction or thickening of the actuator in a plane perpendicular to the effective direction, but this remains unused and is not relevant for the drive.

### BRIEF DESCRIPTION OF THE DRAWINGS

FIG. 1a shows an embodiment of a drive according to the invention in a perspective view. FIG. 1b shows the embodiment of FIG. 1a in an exploded view.

FIGS. 2a and 2b show the deformation behavior of piezoelectric linear actuators in a drive unit of the drive according to the invention, based on an FEM simulation in two different states.

FIG. 3 shows an embodiment of a drive group with several drive units for a linear drive.

FIG. 4 shows another embodiment of a drive group with several drive units for a rotational drive.

### DETAILED DESCRIPTION

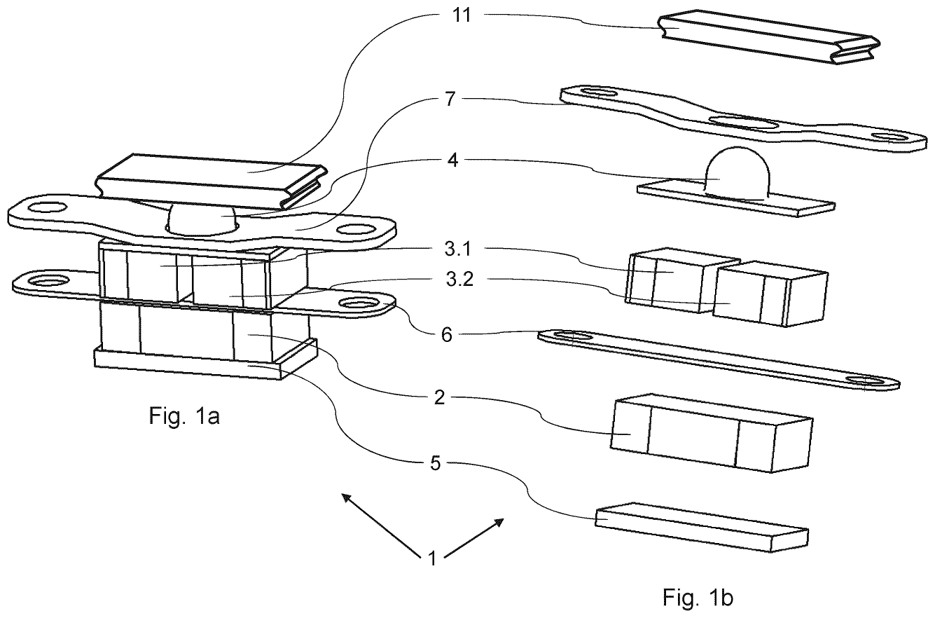

FIGS. 1a and 1b show the structure of the drive according to the invention in a preferred embodiment. Basically, the drive comprises at least one drive unit 1 and one moving member 11. In the present Figures, the moving member 11 is only shown in sections as a flat rod-shaped element, but it can in principle have different shapes. In particular, the moving member 11 can also be configured as a ring or a table or a platform.

The drive unit 1 comprises a first piezoelectric linear actuator 2, which is arranged on a plate-shaped base 5. Two second piezoelectric linear actuators 3.1, 3.2 are coupled to the piezoelectric linear actuator 2 via a carrier 6. The linear actuators 2, 3.1 and 3.2 are each cuboid in shape. The second two linear actuators 3.1 and 3.2 are arranged next to each other on the carrier 6. The carrier 6 is located between the upper end face of the first linear actuator 2 and the lower end faces of the second two linear actuators 3.1, 3.2. With the carrier 6, the assembly of linear actuators is consequently divided into two planes, wherein the first linear actuator 2 is positioned in a first plane and the two second linear actuators 3.1 and 3.2 are positioned in a second plane located above the first plane. Furthermore, the first linear actuator 2 is more than twice as wide as one of the second linear actuators 3.1, 3.2, so that the two second linear actuators 3.1, 3.2 can be arranged within the width of the first linear actuator 2. Instead of a wide first linear actuator 2, two or more first linear actuators can also be used, the width of each of which is smaller. In the present embodiment, all linear actuators 2, 3.1 and 3.2 have the same height and depth, but other dimensions are conceivable. Preferably, each of the linear actuators 2, 3.1 and 3.2 is configured as a stack or multilayer actuator, which is constructed by an alternating arrangement of ceramic layers and internal electrodes. Each of the linear actuators 2, 3.1 and 3.2 has a surface electrode on one of its side surfaces for the electrical contact-connecting of the internal electrodes.

Furthermore, the drive unit 1 comprises a frictional element 4, which is provided on a plate-shaped base. The frictional element is connected to the upper end faces of the two second linear actuators 3.1, 3.2 via the plate-shaped base. The frictional element 4 is hemispherical or dome-shaped and is provided to establish contact with a flat underside of the moving member 11.

Furthermore, the drive unit 1 comprises a spring element 7, by means of which a biasing force can be applied to the linear actuators 2, 3.1, 3.2. The spring element 7 is configured as a metal strip which comprises at each of its two ends a mounting section for attachment to a frame structure receiving the drive unit 1. Each mounting section preferably has a bore. A center section of the spring element 7 is offset parallel to the mounting sections and has a bore through which the frictional element can protrude. In the mounted state, the center section of the spring element 7 presses on the base of the frictional element 4 and thus exerts a pressure force on the linear actuators 2, 3.1, 3.2, so that they are subject to a bias. Similar to the spring element 7, the carrier 6 is also configured as a metal strip that can be attached to the frame structure using mounting sections. In addition to metal, other materials are also conceivable for the carrier 6 and the spring element 7.

By means of a control unit, the individual linear actuators 2, 3.1 and 3.2 can be actuated with suitable electrical voltages. In this case, the linear actuators 2, 3.1 and 3.2 are actuated in such a way that the frictional element 4 can execute both a contact movement towards the moving member 11 or away therefrom for establishing or terminating a contact with the moving member 11 and a drive movement along the moving member 11 for driving it.

The contact movement of the frictional element 4 can be generated in particular by actuating the first linear actuator 2. Upon actuation with an electrical voltage, the first linear actuator 2 expands or contracts in a direction perpendicular to the base 5. This movement is first transmitted to the carrier 6 and finally to the second two linear actuators 3.1, 3.2 on the frictional element 4. Consequently, the contact movement of the frictional element 4 is a movement of the frictional element in a direction perpendicular to the base 5. A regular vibration of the frictional element 4 in the direction perpendicular to the base 5 is achieved, for example, by applying a sinusoidal alternating voltage to the first linear actuator 2.

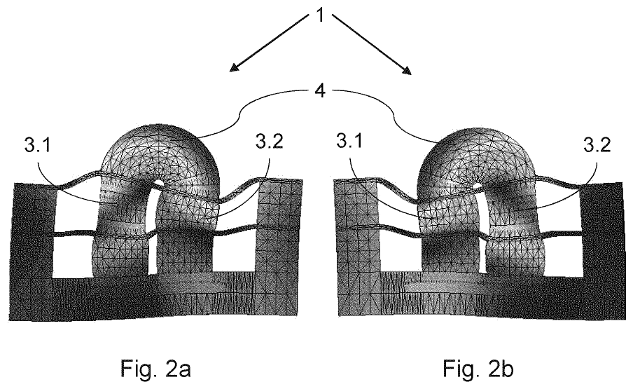

The driving movement of the frictional element 4 can be generated by suitable actuation of the two second linear actuators 3.1, 3.2. Each of the two second linear actuators 3.1, 3.2 is also adapted to expand or contract in a direction perpendicular to the base 5 upon actuation by an electrical voltage. However, the two second linear actuators 3.1, 3.1 are actuated in such a way that they behave in opposite ways or oscillate inversely phased. This behavior is illustrated in FIGS. 2a and 2b. In the state shown in FIG. 2a, the first of the second linear actuators 3.1 is expanded and the second of the second linear actuators 3.2 is contracted. The frictional element 4, which is connected via a base to both second linear actuators 3.1, 3.2, undergoes a tilting movement in the direction of the contracted second linear actuator 3.2 in this state. In an opposing state, shown in FIG. 2b, the first of the second linear actuators 3.1 is contracted and the second of the second linear actuators 3.2 is expanded. In this state, the frictional element 4 undergoes a tilting movement in the direction of the contracted first linear actuator 3.1. The tilting movements of the frictional element 4 consequently enable a driving movement or a resetting movement in a direction parallel to the base 5. Regular oscillation of the frictional element 4 in the direction parallel to the base 5 is achieved, for example, by applying a sinusoidal alternating voltage to each of the two second linear actuators 3.1, 3.2, wherein these alternating voltages are phase-shifted by 180°with respect to each other. In this case, the polarization directions of the two second linear actuators 3.1, 3.2 are the same. In the case where the polarization directions of the two second linear actuators 3.1, 3.2 are opposite to each other, the two second linear actuators 3.1, 3.2 can be actuated with the same sinusoidal alternating voltage without phase shift.

According to the configuration of the drive according to the invention, the contact movement and the drive movement of the frictional element 4 can be executed independently of each other or overlapped. This means that by actuating only the first linear actuator 2, the frictional element 4 can initially perform the contact movement in the direction of the moving member 11 until it comes into contact with the underside of the moving member 11 and exerts a certain contact pressure on the moving member 11. The two second linear actuators 3.1, 3.2 can then be actuated in such a way that the frictional element 4 performs a tilting movement in a direction parallel to the underside of the moving member 11, as described above. The frictional element 4 pressed against the moving member 11 thereby causes the moving member 11 to be propelled in this direction. By suitably actuating the first linear actuator 2, the contact between the frictional element 4 and the underside of the moving member 11 can be terminated again. Finally, the two second linear actuators 3.1, 3.2 can be actuated in such a way that the frictional element 4 performs a tilting movement in the opposite direction and consequently a resetting movement. A continuous propulsion of the moving member 11 is made possible by repeating these actuation steps.

On the other hand, it is also possible to actuate the linear actuators 2, 3.1 and 3.2 in such a way that the contact movement and the drive movement of the frictional element 4 overlap. This can result in an elliptical oscillation path of the frictional element 4, the major axis of which is inclined with respect to the underside of the moving member 11. If the frictional element 4 oscillates on this path, continuous propulsion of the moving member is also achieved.

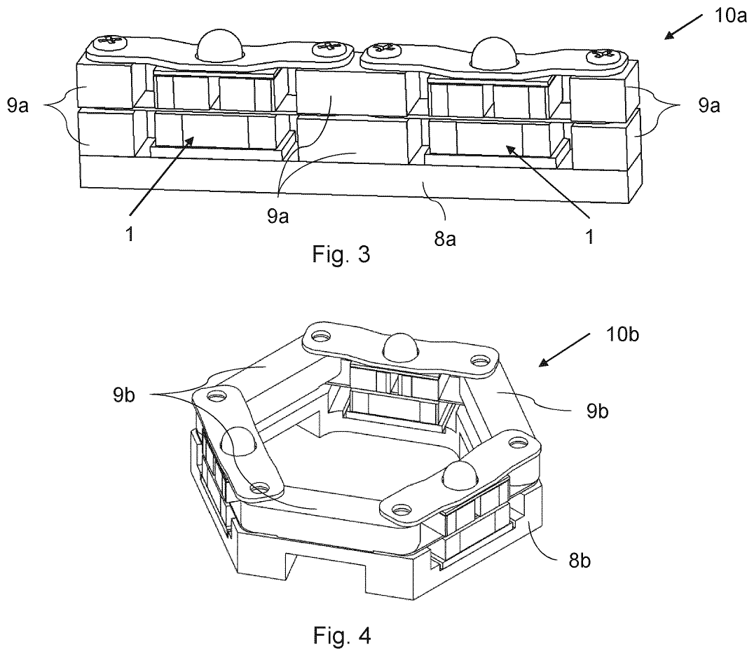

FIG. 3 shows a drive group 10a in which two drive units 1 are arranged next to each other and fixed in a common frame 8a, 9a. In particular, each drive unit 1 is arranged on a base element 8a and attached to structural elements 9a via the carrier 6 and the spring element 7 by means of screws. The drive units 1 are arranged along the feed direction of a moving member and thus extend the stroke of the moving member or, in the case of a correspondingly long moving member, double the driving force acting on the moving member. The use of two drive units arranged next to each other is only an example. Of course, three or more drive units can also be arranged next to each other in a corresponding frame. The frame 8a, 9a can also consist of several elements or even be configured in one piece, as long as it provides suitable receiving sections for the drive units 1.

FIG. 4 shows a drive group 10b in which three drive units 1 are arranged along a circular path and fixed in a common frame 8b, 9b. The attachment of the drive units to the base element 8b and the structural elements 9b of the frame is essentially the same as that described in connection with FIG. 3. Due to the fact that the drive units 1 are arranged on a circular path, a rotational drive can be realized using an annular moving member. Similarly to the embodiment according to FIG. 3, the frame 8b, 9b of the present embodiment can also consist of several elements or be configured in one piece.

1-16. (canceled)

17. A piezoelectric motion-and resonance drive, comprising:
a moving member, and
at least one drive unit comprising an assembly of a plurality of piezoelectric actuators and a frictional element adapted to come into contact with the moving member,
wherein the assembly of the piezoelectric actuators and the frictional element are coupled so that, upon actuation of the piezoelectric actuators, the frictional element is configured to perform both:
a contact movement towards the moving member or away therefrom in order to establish or terminate contact with the moving member; and
a drive movement along the moving member in order to drive the latter,
wherein each of the piezoelectric actuators of the assembly is a linear actuator.

18. The piezoelectric motion-and resonance drive according to claim 17, wherein the assembly of the piezoelectric actuators and the frictional element are coupled so that upon actuation of the piezoelectric actuators, the frictional element is configured to perform the contact movement and the driving movement independently of each other or in an overlapping manner.

19. The piezoelectric motion-and resonance drive according to claim 17, wherein the driving movement occurs in a plane or along an axis perpendicular to an axis of the contact movement.

20. The piezoelectric motion-and resonance drive according to claim 17, wherein the drive unit comprises a base which carries the assembly of the piezoelectric actuators, and
the contact movement occurs perpendicular to the base and/or the drive movement occurs parallel to the base.

21. The piezoelectric motion-and resonance drive according to claim 17, wherein the piezoelectric actuators of the assembly, upon actuation, are deflected in parallel directions.

22. The piezoelectric motion-and resonance drive according to claim 17, wherein each of the piezoelectric actuators is a multilayer stack actuator configured to produce a deflection along its stacking axis.

23. The piezoelectric motion-and resonance drive according to claim 17, wherein the piezoelectric actuators are assigned actuator units configured to be actuated separately, and
upon actuation of a first actuator unit with at least one of the piezoelectric actuators, the frictional element performs the contact movement and upon actuation of a second actuator unit with at least one other of the piezoelectric actuators, the frictional element performs the driving movement.

24. The piezoelectric motion-and resonance drive according to claim 17, wherein the piezoelectric actuators are provided within the assembly in a plurality of planes, and
all piezoelectric actuators of the same actuator unit are arranged in the same plane.

25. The piezoelectric motion-and resonance drive according to claim 24, wherein a carrier is arranged between two planes and the piezoelectric actuators of the different planes are coupled to one another via the carrier.

26. The piezoelectric motion-and resonance drive according to claim 17, wherein the frictional element is connected to two piezoelectric actuators arranged next to each other within the assembly, preferably via a base that carries the frictional element.

27. The piezoelectric motion-and resonance drive according to claim 17, wherein the drive unit is mounted in a frame.

28. The piezoelectric motion-and resonance drive according to claim 17, wherein the assembly of the piezoelectric actuators comprises three piezoelectric actuators,
one of the piezoelectric actuators is arranged in a first plane,
two of the piezoelectric actuators are arranged in a second plane located above the first plane, and
the two of the piezoelectric actuators of the second plane are arranged next to each other.

29. The piezoelectric motion-and resonance drive according to claim 17, wherein the at least one drive unit comprises:
at least two drive units arranged next to each other in a direction parallel to the direction of the driving movement; or
at least three drive units are arranged along a circular path.

30. The piezoelectric motion-and resonance drive according to claim 17, wherein the drive comprises a controller configured to actuate the piezoelectric actuators with electric control voltages.

31. A method for actuating a piezoelectric motion-and resonance drive, comprising:
providing a moving member;
providing at least one drive unit comprising an assembly of a plurality of piezoelectric linear actuators and a frictional element adapted to come into contact with the moving member,
actuating at least one piezoelectric linear actuator of the assembly so that the frictional element performs a contact movement towards the moving member or away therefrom, in order to establish or terminate contact with the moving member, and so that at least one other piezoelectric linear actuator of the arrangement is actuated so that the frictional element performs a driving movement along the moving member.

32. The method according to claim 31, wherein the two piezoelectric linear actuators that cause the driving movement of the frictional element are actuated such that they are inversely phased.

33. The piezoelectric motion-and resonance drive according to claim 27, wherein the drive unit is mounted in the frame via a carrier that penetrates the assembly of the piezoelectric actuators and/or a spring element which biases the assembly of piezoelectric actuators against the frame.
